(19) United States
(12) Patent Application Publication
(10) Pub. No.: US 2022/0126179 A1
(43) Pub. Date: Apr. 28, 2022

(54) PORTABLE GOLF CLUB CLEANING TOOL

(71) Applicant: Som Boualyvongsane, Auburn Hills, MI (US)

(72) Inventor: Som Boualyvongsane, Auburn Hills, MI (US)

(21) Appl. No.: 17/082,559

(22) Filed: Oct. 28, 2020

(51) Int. Cl. A63B 57/60; B08B 7/00

(52) U.S. Cl. CPC A63B 57/60; A63B 2209/00; B08B 7/00

(57) ABSTRACT

A portable golf club cleaning tool apparatus for removing debris from the golf club head, comprised of a bag adapted to be hand-held comprised of a plurality of openings or pores; a plurality of granular particles held in the bag, and where the golf club cleaning tool is adapted to clean debris off the head of the golf club when the golf club cleaning tool is moistened with a liquid and a user scrubs the head of the golf club with the bag as the granular particles seep out of the bag.

### BACKGROUND OF THE INVENTIVE FIELD

The present invention is directed to a portable golf club cleaning tool or apparatus. The golf club cleaning tool is preferably comprised of a bag having small openings or pores that is filled with sand or other coarse, granular, material. The small openings or pores in the bag are preferably configured to allow the sand within the bag to seep out of the bag during use. Once the bag is moistened with water, the user can use the bag to scrub a golf club head portion to remove debris such as grass, mud, and ball marks from the club head. The sand in the bag seeps out during use and scrubs against the club head as the user rubs the club head with the bag. The coarseness of the sand allows the club head to be cleaned while the granularity of the sand prevents the club head from being scratched. The granularity of the sand also allows it to get into the grooves and indentations in the golf club to better clean the golf club compared to other known cleaners. The invention of the present invention also finds that fine sand (1-2 mm in size, but preferably less than 1 mm in size) is better suited to allow adequate cleaning of the golf club head. The tool of the present invention can also be used to clean dirt and other marks off golf balls.

Previous golf club cleaning tools generally comprise of some kind of brush for scrubbing the golf clubs. These typical brushes are inadequate because they do not remove debris from the golf club completely or in an efficient manner. These prior brushes also can scratch the surface of the golf club.

There have been other cleaning type products like drafting eraser bags that are filled with eraser-type powder or crumbs for cleaning smudges or lead on draft paper or mats. However, these drafting eraser bags are filled with rubbery type, eraser-like, substances that would not sufficiently clean a golf club head. Additionally, these drafting eraser bags are not meant to be used with liquid or moisture of any kind as the present invention.

Many professional golfers and caddies use a bucket of water and a towel to clean golf clubs after a round of golf. This method of cleaning is also inadequate as it is time consuming (the golf clubs are left to soak for an extended period of time), and the method requires a bucket of water and, therefore, cannot be performed on the golf course.

The golf club cleaning tool of the present invention solves the problems presented by these prior methods by providing a portable golf cleaning tool that effectively and efficiently removes debris from a golf club head.

### SUMMARY OF THE GENERAL INVENTIVE CONCEPT

In one embodiment of the invention, the invention is a portable golf club cleaning tool apparatus for removing debris from the golf club head, preferably comprised of a bag adapted to be hand-held comprised of a plurality of openings or pores, a plurality of granular particles held in the bag and wherein the granular particles are abrasive, wherein the golf club cleaning tool, including the bag and the granular particles, is adapted to be moistened with a liquid, wherein the plurality of openings or pores in the bag are configured to allow the granular particles held in the bag to seep out of the bag during use, and wherein the golf club cleaning tool is adapted to clean debris off the head of the golf club when the golf club cleaning tool is moistened with a liquid and a user scrubs the head of the golf club with the bag as the granular particles seep out of the bag.

In one embodiment, the bag is stored in a pouch made from waterproof material or fabric comprised of an opening for accepting the bag, where the pouch is adapted to be closed so the granular particles will not leak from the pouch, and wherein the pouch is of sufficient size to hold the bag while not allowing it to substantially move around in the pouch.

In one embodiment, the golf head cleaning tool of the present is comprised of a second bag adapted to be hand-held comprised of a plurality of openings or pores, a plurality of granular particles held in the second bag and where the plurality of granular particles held in the second bag are abrasive, wherein the bag and the second bag are configured in a sandwich configuration for cleaning both sides the golf club head at the same time, where the plurality of openings or pores in the second bag are configured to allow the granular particles held in the second bag to seep out of the bag during use, and where the golf club cleaning tool is adapted to clean debris off both sides of the head of the golf club when the golf club cleaning tool is moistened with a liquid and a user scrubs the head of the golf club with the bag and second bag as the granular particles seep out of the bag and second bag.

The present invention also relates to a method of cleaning a golf club using a portable golf club cleaning tool apparatus for removing debris from the golf club head, the method preferably comprising the steps of holding a bag comprised of a plurality of openings or pores and wherein there are a plurality of abrasive, granular particles held in the bag, moistening the golf club cleaning tool, including the bag and abrasive, granular particles with a liquid, scrubbing the head of the golf club with the bag so that the abrasive, granular particles held in the bag seep out of the bag during use, and cleaning debris off the head of the golf club after the golf club cleaning tool is moistened with a liquid. In one embodiment, the method also includes sewing the bag and the second bag to a cover portion made of material that prevents sand from passing through the cover portion, where the cover is preferably made from polyester.

The foregoing and other features and advantages of the present invention will be apparent from the following more detailed description of the particular embodiments, as illustrated in the accompanying drawings.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1 illustrates one embodiment of the bag and storage pouch of the present invention;

FIG. 2 illustrates the bag of FIG. 1 partially stuffed into the pouch of FIG. 1;

FIG. 3 illustrates a user using the golf club cleaning tool of the present invention to scrub the head of a golf club;

FIG. 4 illustrates one embodiment of the invention configured in a sandwich configuration;

FIG. 5 illustrates another embodiment of the invention shown in FIG. 4 having additional holes along the side portions of the bag.

### DETAILED DESCRIPTION OF EXEMPLARY EMBODIMENT(S)

The following detailed description of the example embodiments refers to the accompanying figures that form a part thereof. The detailed description provides explanations by way of exemplary embodiments. It is to be understood that other embodiments may be used having mechanical and electrical changes that incorporate the scope of the present invention without departing from the spirit of the invention.

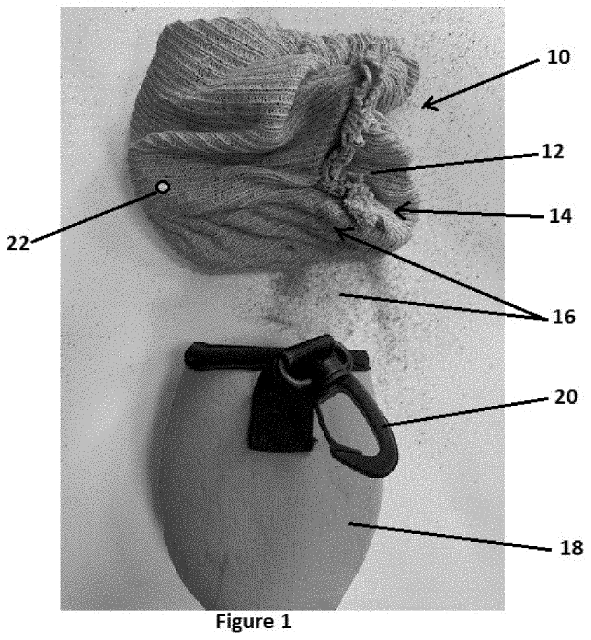

FIG. 1 illustrates one embodiment of the bag and storage pouch of the present invention. The present invention is a portable golf club cleaning tool apparatus 10 for removing debris from the golf club head, preferably comprised of a bag 12 adapted to be hand-held comprised of a plurality of openings or pores (shown generally at 14), a plurality of granular particles 16 (e.g., sand) held in the bag (some of the granular particles are shown out of the bag). The term “bag” as used herein is interchangeable with the terms sack or receptacle. The bag can be of any shape (e.g., round, rectangular, square, oval). The granular particles are abrasive to aid in cleaning the golf club. The golf club cleaning tool, including the bag and the granular particles, is adapted to be moistened with a liquid such as water. The plurality of openings or pores in the bag are configured to allow the granular particles held in the bag to seep out of the bag during use. As the moist sand seeps out of the bag during use, the golf club cleaning tool is adapted to clean debris off the head of the golf club. In other words, the user scrubs the head of the golf club with the bag as the granular particles seep out of the bag. The abrasive sand or other granular particles rub against the golf club head moistening the dirt and debris while removing them as the user scrubs the golf club with the moistened bag.

In one embodiment, the sand is comprised of all-purpose sand made up of particles that are smaller than 1 mm in size. In another embodiment, the sand is made up of particles that are between 1 mm and 2 mm in size. Larger grains of sand can be used, however, the present invention works more effectively with smaller grains of sand as they get into the grooves and crevices of the golf club more effectively to allow better cleaning. In another embodiment, the plurality of granular particles are granular beads made of an abrasive synthetic material such as hard plastic. The bag is preferably made from a mesh fabric (e.g., cotton) and where the openings or pores in the bag are woven voids in the fabric. In another embodiment, the bag is made from synthetic fabric. In a preferred embodiment, the plurality of openings or pores in the bag are large enough to allow sand that is 1 mm in size to seep through the bag.

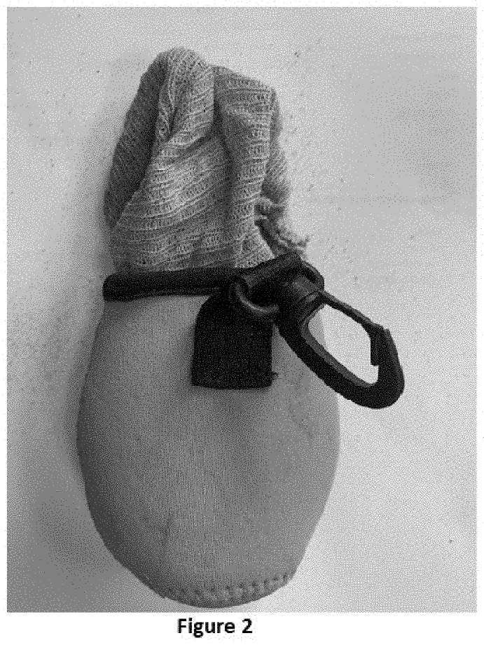

The storage pouch 18 of the present invention is preferably made from waterproof material or fabric comprised of an opening for accepting the bag. The pouch is adapted to be closed so the granular particles will not leak from the pouch. In a preferred embodiment, the the pouch is of sufficient size to hold the bag while not allowing it to substantially move around in the pouch. The pouch preferably has a fastening or clasp means 20 for removably fastening the storage pouch to a golf bag for easier access. In one embodiment the bag has a sealable portal 22 on the bag adapted to be closed off for allowing the bag to be refilled with additional granular particles. It is also appreciated that the bag does not have a refillable portal (instead the bag is disposed of after substantial use after the fabric is worn out or the granular particles have all seeped out of the bag). The bag is preferably made from a stretchable fabric and where the plurality of openings or pores are adapted to stretch to a bigger size during use to allow the granular particles to seep out of the bag during use. FIG. 2 illustrates the bag of FIG. 1 partially stuffed into the pouch of FIG. 1.

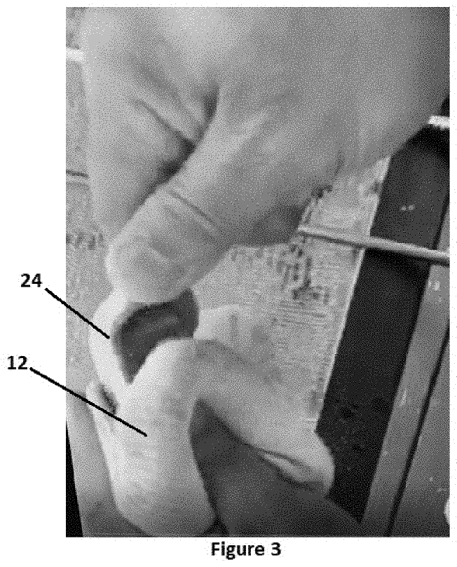

FIG. 3 illustrates a user using the golf club cleaning tool of the present invention to scrub the head of a golf club. The present invention also relates to a method of cleaning a golf club using the portable golf club cleaning tool apparatus for removing debris from the golf club head 24 comprising the steps of:
1. holding the bag having a plurality of openings or pores and where there are a plurality of abrasive, granular particles held in the bag;
2. moistening the golf club cleaning tool, including the bag and abrasive, granular particles with a liquid (e.g., water);
3. scrubbing the head of the golf club with the bag so that the abrasive, granular particles held in the bag seep out of the bag during use;
4. cleaning debris off the head of the golf club after the golf club cleaning tool is moistened with a liquid;
5. storing the bag in a pouch made from waterproof material or fabric comprised of an opening for accepting the bag;
6. closing the pouch so the abrasive, granular particles will not fall out of the pouch.

In one embodiment the user can refill the bag with additional abrasive, granular particles through a sealable portal on the bag adapted to be closed off. The method also may involve straining the plurality of abrasive, granular particles to remove particles greater than 1 mm in size before placing the plurality of abrasive, granular particles in the bag.

The plurality of abrasive, granular particles can also be baked in an oven at 150 degrees for five hours or more prior to placing the plurality of abrasive, granular particles in the bag. This process purifies the particles of bacteria and other dangerous substances.

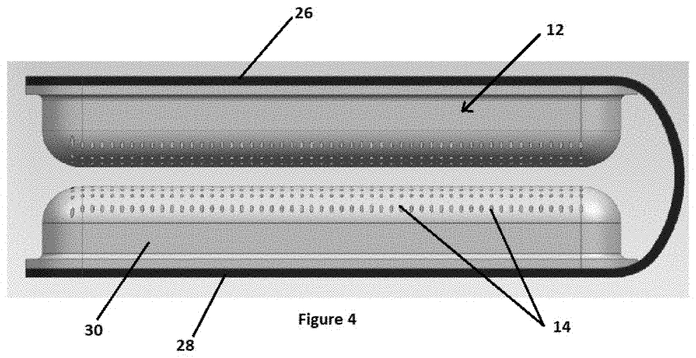

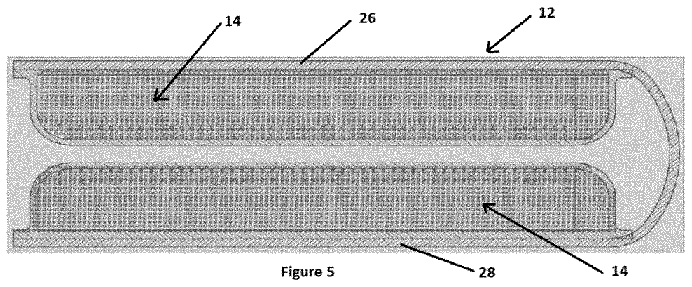

FIG. 4 illustrates one embodiment of the invention configured in a sandwich configuration. A sandwich configuration relates to where a bag or plurality of bags of the present invention are configured so that two opposing sides of the bag(s) are sandwiched between top and bottom cover portions, 26, 28 respectively, so that a user can grab the cover and place a golf club head in between the bag(s) to clean both sides of the golf club head at the same time. In the embodiment shown in FIG. 4, there are portions of the bag 30 that do not have holes. FIG. 5 illustrates another embodiment of the invention shown in FIG. 4 having additional holes on all portions of the bag that are exposed.

The embodiment shown in FIG. 4, has a top and bottom bag sandwiched between the top and bottom cover portions 26, 28. The top and bottom bag can also be one continuous bag sandwiched between the top and bottom cover portions. This embodiment is comprised of a first and second bag, each adapted to be hand-held comprised of a plurality of openings or pores, a plurality of abrasive, granular particles held in the first and second bags, and where the plurality of openings or pores in the first and second bags are configured to allow the granular particles held in the bags to seep out of the bags during use, and where the golf club cleaning tool is adapted to clean debris off both sides of the head of the golf club when the golf club cleaning tool is moistened with a liquid and a user scrubs the head of the golf club with the first and second bags as the granular particles seep out of the bags. In one embodiment, the bags are about 114.3 mm by 76.2 mm in size.

In one embodiment, the bags shown in FIGS. 4 and 5 are sewn to the cover portion. The cover portion can be made from a fabric such as polyester. The cover portion is preferably made of material that prevents sand from passing through the cover portion.

While certain embodiments of the present invention are described in detail above, the scope of the invention is not to be considered limited by such disclosure, and modifications are possible without departing from the spirit of the invention as evidenced by the following claims:

What is claimed is:

1. A portable golf club cleaning tool apparatus for removing debris from the golf club head, comprised of:
a bag adapted to be hand-held comprised of a plurality of openings or pores;
a plurality of granular particles held in the bag and wherein the granular particles are abrasive;
wherein the golf club cleaning tool, including the bag and the granular particles, is adapted to be moistened with a liquid;
wherein the plurality of openings or pores in the bag are configured to allow the granular particles held in the bag to seep out of the bag during use; and
wherein the golf club cleaning tool is adapted to clean debris off the head of the golf club when the golf club cleaning tool is moistened with a liquid and a user scrubs the head of the golf club with the bag as the granular particles seep out of the bag.

2. The apparatus of claim 1, wherein the plurality of granular particles are abrasive sand.

3. The apparatus of claim 2, wherein the sand is comprised of all-purpose sand made up of particles that are smaller than 1 mm in size.

4. The apparatus of claim 2, wherein the sand is made up of particles that are between 1 mm and 2 mm in size.

5. The apparatus of claim 1, wherein the plurality of granular particles are granular beads.

6. The apparatus of claim 1, wherein the bag is made from a mesh fabric or cotton and wherein the openings or pores in the bag are woven voids in the fabric.

7. The apparatus of claim 1, wherein the bag is made from synthetic fabric.

8. The apparatus of claim 1, wherein the bag is configured in a sandwich configuration between a cover portion for cleaning both sides of the golf club at the same time.

9. The apparatus of claim 1, wherein the plurality of openings or pores in the bag are large enough to allow sand that is 1 mm in size to seep through the bag.

10. The apparatus of claim 1, further comprising:
a pouch made from waterproof material or fabric comprised of an opening for accepting the bag;
wherein the pouch is adapted to be closed so the granular particles will not leak from the pouch; and
wherein the pouch is of sufficient size to hold the bag while not allowing it to substantially move around in the pouch.

11. The apparatus of claim 1, further comprising:
a sealable portal on the bag adapted to be closed off for allowing the bag to be refilled with additional granular particles.

12. The apparatus of claim 1, wherein the bag is made from a stretchable fabric and wherein the plurality of openings or pores are adapted to stretch to a bigger size during use to allow the granular particles to seep out of the bag during use.

13. The apparatus of claim 1, further comprising:
a second bag adapted to be hand-held comprised of a plurality of openings or pores;
a plurality of granular particles held in the second bag and wherein the plurality of granular particles held in the second bag are abrasive;
wherein the bag and the second bag are configured in a sandwich configuration for cleaning both sides the golf club head at the same time;
wherein the plurality of openings or pores in the second bag are configured to allow the granular particles held in the second bag to seep out of the bag during use; and
wherein the golf club cleaning tool is adapted to clean debris off both sides of the head of the golf club when the golf club cleaning tool is moistened with a liquid and a user scrubs the head of the golf club with the bag and second bag as the granular particles seep out of the bag and second bag.

14. A method of cleaning a golf club using a portable golf club cleaning tool apparatus for removing debris from the golf club head, the method comprising the steps of:
holding a bag comprised of a plurality of openings or pores and wherein there are a plurality of abrasive, granular particles held in the bag;
moistening the golf club cleaning tool, including the bag and abrasive, granular particles with a liquid;
scrubbing the head of the golf club with the bag so that the abrasive, granular particles held in the bag seep out of the bag during use; and
cleaning debris off the head of the golf club after the golf club cleaning tool is moistened with a liquid.

15. The method of claim 14, further comprising the steps of:
storing the bag in a pouch made from waterproof material or fabric comprised of an opening for accepting the bag;
closing the pouch so the abrasive, granular particles will not fall out of the pouch; and
wherein the pouch is of sufficient size to hold the bag while not allowing it to substantially move around in the pouch.

16. The method of claim 14, further comprising the step of:
refilling the bag with additional abrasive, granular particles through a sealable portal on the bag adapted to be closed off.

17. The method of claim 14, wherein the bag is made from a stretchable fabric and further comprising the step of stretching a plurality of openings or pores in the bag to a bigger size during use to allow the abrasive, granular particles to seep out of the bag during use.

18. The method of claim 14, further comprising the step of:
straining the plurality of abrasive, granular particles to remove particles greater than 1 mm in size before placing the plurality of abrasive, granular particles in the bag.

19. The method of claim 14, further comprising the step of:
baking the plurality of abrasive, granular particles in an oven at 150 degrees for five hours or more prior to placing the plurality of abrasive, granular particles in the bag.

20. The method of claim 14, further comprising the step of:
making a pad for cleaning both sides of a golf club at the same time by configuring the bag and a second bag filled with a plurality of abrasive, granular particles in a sandwich configuration;
sewing the bag and the second bag to a cover portion made of material that prevents sand from passing through the cover portion.
